(19) United States
(12) Patent Application Publication
(10) Pub. No.: US 2013/0117246 A1
(43) Pub. Date: May 9, 2013

(54) METHODS OF PROCESSING TEXT DATA

(71) Applicants: Sebastien Cabaniols, Echirolles (FR); Nathalie Cabaniols-Viollet, Echirolles (FR); Clément Poulain, Grenoble (FR)

(72) Inventors: Sebastien Cabaniols, Echirolles (FR); Nathalie Cabaniols-Viollet, Echirolles (FR); Clément Poulain, Grenoble (FR)

(21) Appl. No.: 13/288,525

(22) Filed: Nov. 3, 2011

(51) Int. Cl. G06F 17/30

(52) U.S. Cl. 707/697; 707/749; 707/E17.084; 707/E17.007

(57) ABSTRACT

Examples of the present invention provide methods relating to identification of a portion of text data common with reference text data, the method including obtaining the text data and the reference text data, the text data and the reference text data comprising a number of lines of text, identifying one or more lines of text of the text data that are common to the lines of text of the reference text data, and for one or more further lines of text of the text data that are not common to the lines of text of the reference text data, comparing the line of text of the text data with a corresponding line of text of the reference data to identify one or more common characters of the line of text.

### BACKGROUND

A number of techniques have been developed for managing large numbers of computing systems, and a number of tools are available. For example, many tools exist to broadcast commands to multiple systems and to perform basic synthesis of the outputs.

One commonly used tool is PDSH (Parallel Distributed Shell), which is a remote shell client able to execute commands on multiple remote hosts in parallel. Thus, by typing a shell command on a PDSH shell, it is possible to broadcast this command to a selection of computing nodes.

The ability to broadcast commands to multiple systems can be particularly useful in managing large systems that comprise clusters of computing nodes, for example as used to provide high-performance computing clusters or supercomputers which may comprise hundreds, or sometimes thousands, of computing nodes.

When using PDSH to execute a command on a number of nodes, the output from each command is then returned to the PDSH shell window for display to the operator. In order to help improve the manageability of the returned data, the DSHBAK tool is often used. DSHBAK operates as a filter that is able to format the standard PDSH output. Outputs from different nodes that are identical are identified and consolidated, such that identical outputs are not duplicated in the information displayed to the operator. A header is then provided for each output to indicate the remote host nodes to which the output is associated. However, any difference between two outputs leads to the entirety of the two outputs being displayed.

### BRIEF INTRODUCTION OF THE DRAWINGS

Embodiments of the present invention are further described hereinafter by way of example only with reference to the accompanying drawings, in which:

FIG. 1 illustrates a multi-node computing system suitable for implementing some embodiments of the invention; and

FIG. 2 illustrates a method of merging files according to some embodiments of the invention;

FIG. 3 illustrates a method of identifying differing lines of files according to some embodiments of the invention;

FIG. 4 illustrates Ratcliff's pattern matching algorithm as used by some embodiments of the invention;

FIG. 5 shows an example of common character detection illustrating the differences between Ratcliff's algorithm and a Smart-Merge algorithm according to some embodiments of the invention

FIG. 6 illustrates a method of determining a similarity score between text strings according to some embodiments of the invention;

FIG. 7 shows an outline view of a computing node suitable for implementing embodiments of the invention; and

FIG. 8 shows an example output of a merged reference file according to some embodiments of the invention.

### DETAILED DESCRIPTION OF AN EXAMPLE

Embodiments of the present invention provide a method of merging multiple files with similar content. In particular, some embodiments of the invention are applicable to merging a large number of files having one or more small differences to produce a significantly reduced but complete summary of all of the merged files that emphasizes the differences while filtering out non-relevant and repetitive data.

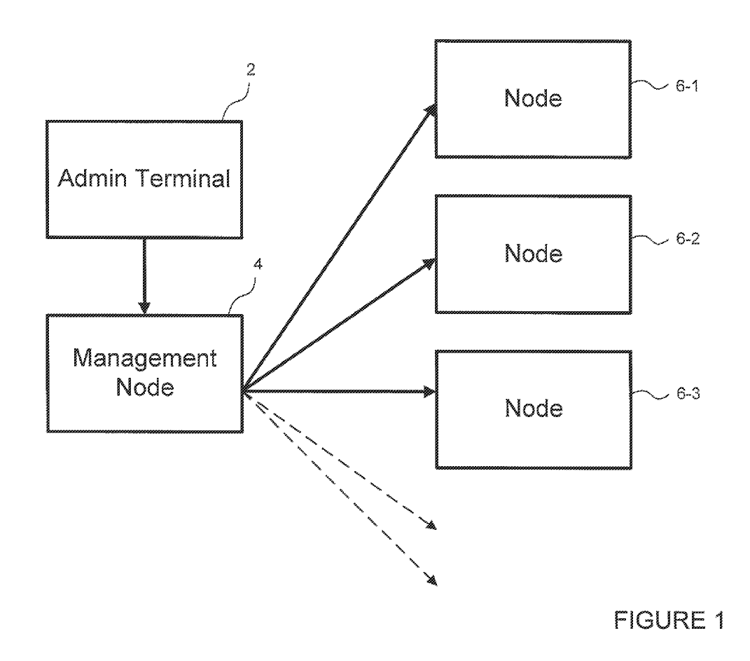

FIG. 1 illustrates a multi-node computing system 1 suitable for implementing embodiments of the invention. The system illustrated in FIG. 1 comprises a plurality of nodes 6-1, 6-2, 6-3, etc. coupled to a management node 4. An administration terminal 2 is coupled to the management node 4, and via the management node 4 to the nodes 6.

It will be understood that in some embodiments the role of the management node 4 could be served by any of the nodes 6, and/or by the administration terminal 2.

In use, a command may be issued to multiple nodes 6 in parallel using a PDSH shell, and each node may then return a file, or output, in response to the command for viewing by an operator on the administration terminal 2. As the same command is being executed on each node 6, the response files provided by the nodes 6 to the management node 4 are generally similar in form and content. Indeed, often it is the differences between the outputs that highlight the important data to be presented to the operator. For example, high performance cluster computing systems are generally built from homogenous hardware nodes, and differences in configuration information can represent errors in system setup.

Throughout this disclosure, the terms file and output are used interchangeably to represent any text data comprising one or more lines of character strings.

For management nodes implementing the DSHBAK tool to handle multiple responses, any difference present in a response file from a node causes that response not to be consolidated but duplicated. This means that if there is a trivial one-character difference in the response file the file will be duplicated in the output, leading to increased effort required to monitor the outputs in response to the parallel executed command.

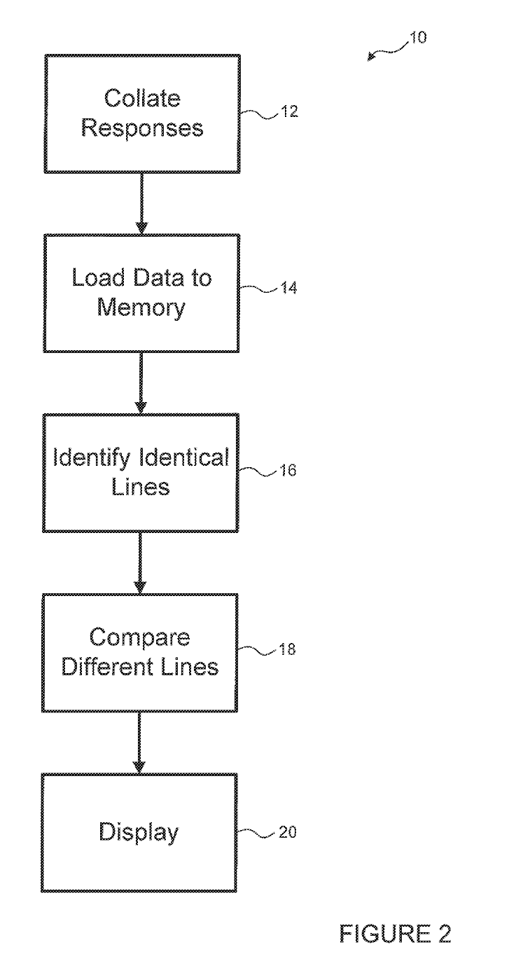

FIG. 2 illustrates a method 10 according to some embodiments of the invention that allows the multiple responses to be merged to provide a more intuitive merged output to an operator. In step 12, the response strings provided by the nodes 6 in response to the parallel executed command are collected at the management node 4, whereby each response is aggregated into a file associated with the one of the nodes 6 generating the response. Thus, for commands eliciting multi-line responses a file is generated comprising the complete response text. The file data is then loaded into memory at step 14. Each file is loaded into memory line-by-line, and at the same time a number of attributes of the line are computed. The attributes may include one or more of: a line length, a display length, and a checksum representing the line.

Having loaded the file data into memory, a determination is made as to which lines of the files differ between pairs of files in step 16. In order to perform the determination, one file is assigned to be a reference file against which other files should be compared. For example, according to embodiments, the reference file may be explicitly selected by an operator or may be designated as the file relating to the node providing the first received response. Thus, the lines differencing step 16 identifies lines of a file that are identical to, and that differ from, the corresponding lines of the reference file. For those lines identified as different from the corresponding lines of the reference file, a string comparison is performed to identify which characters in the line are different in step 18.

The results of the merged response files can then be displayed at step 20, by building a synthetic output based on the content of the reference file with any differences highlighted. As each response file is compared against the same reference file, only a single response (the reference file) needs to be displayed in full, with the differences of other response files annotated to the displayed response to notify the operator of the differences with the other response files.

Thus, in comparison with the output generated through the use of DSHBAK, responses are not duplicated due to trivial, or single character differences between responses.

As will be recognized, the comparison of each file with the reference file can be easily separated into multiple threads that can be executed in parallel on more than one processing resource, such as a processing core, to increase the speed of the method.

According to some embodiments of the invention, prior to processing of the response files to generate the merged response, the metadata of each response file is examined and used to filter the input response files. This metadata filtering may operate to identify inputs where data collection has failed (invalid report, data not collected in time, permission problems, etc) and to generate an inventory of different types of failures.

It is common with large servers comprising a very large number of computing nodes, that some nodes will be unavailable due to servicing, etc. Comparing ‘empty’ responses from unavailable nodes will lead to all of the synthetic response being identified as different in some responses which may serve to obfuscate the data shown to the operator. Pre-filtering the input response files allows such empty files to be excluded from the analysis. According to some embodiments, information relating to different types of failures, and the identities of failed nodes, may be displayed to the operator, for example as part of a header to the synthetic response file.

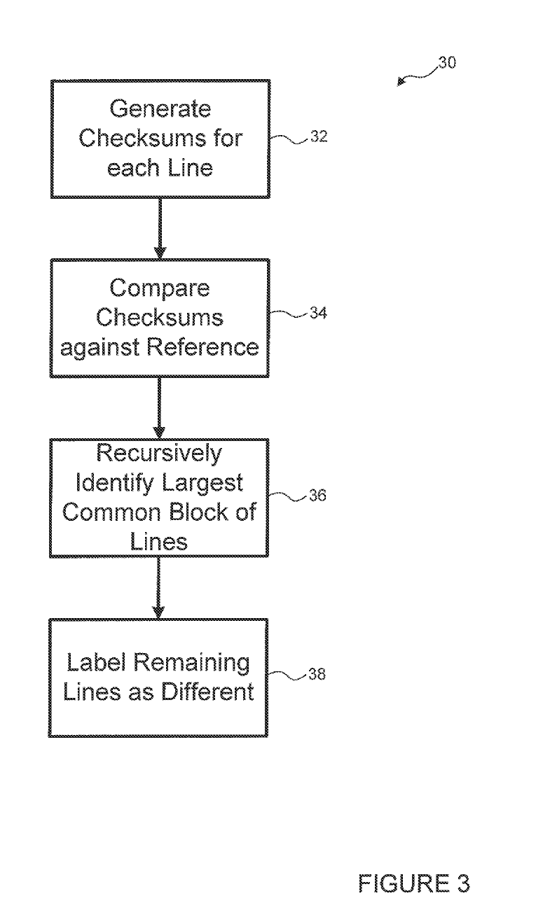

FIG. 3 illustrates a method 30 of comparing two files to identify identical and different lines according to some embodiments of the invention. For example, the method illustrated in FIG. 3 can be used to implement step 16 of the method 10 illustrated in FIG. 2, although it will be recognized that other implementations of step 16 are possible, such as through use of the Unix diff function, and are contemplated in this disclosure.

The method 30 illustrated in FIG. 3 relies on the generation of checksums, or hash values, for each line of a file in step 32. For example, the checksums may comprise 64-bit integers for ease of processing on a 64-bit processor. By comparing the checksums generated for a line in a response file against checksum values for lines of the reference file a determination can be made as to whether lines are identical.

While the use of checksums allows individual lines in a response file to be matched with corresponding lines in a reference file, it is possible that multiple matches will be generated, due to identical lines present in files. Thus, according to embodiments of the invention, rather than simply looking for individual line matches, an attempt is made to match blocks of lines in step 34. In order to match blocks of lines, as opposed to individual lines, a modification of a string comparison algorithm was applied to the checksum values associated with the response file and the reference file. In particular, embodiments of the invention implement a modified form of the Ratcliff algorithm.

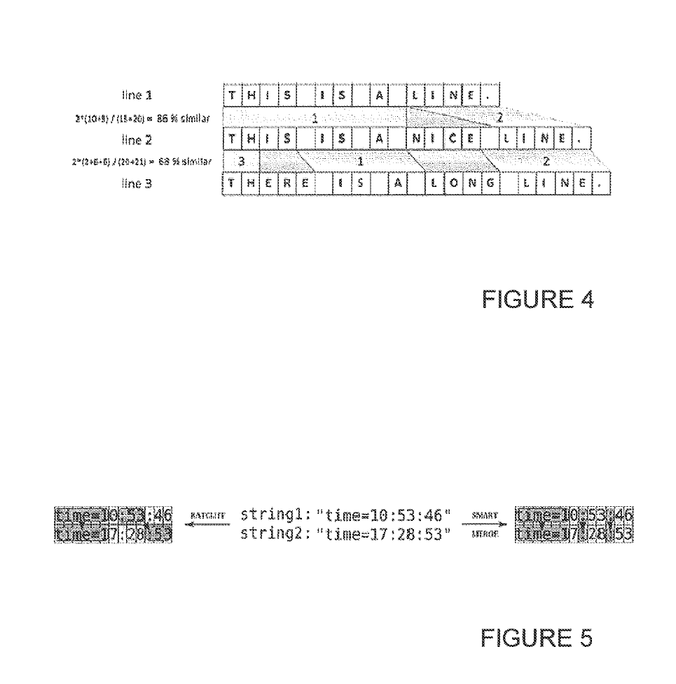

The Ratcliff algorithm is conventionally used to compute the similarity of two strings as the number of matching characters divided by the total number of characters in the two strings. Matching characters are defined as those in the longest common sequence plus, recursively matching characters in the unmatched region on either side of the longest subsequence. An example of the operation of the Ratcliff algorithm is shown in FIG. 4.

By applying this algorithm to the checksum values associated with lines of text in the response file and reference file rather than to characters within a line, the longest common sequence of lines is determined, and then recursively blocks of lines in the unmatched region on either side of the longest subsequence are matched.

The result is to identify blocks of lines in step 36 which match corresponding lines in the reference file, and one or more lines which do not match, and therefore contain character differences. The lines which do not match can then be labeled as different in step 38 for subsequent analysis.

The ability to quickly identify identical blocks of lines may be particularly relevant to the case in which a large number of lines are expected to be identical, as might be expected when a large number of computing nodes execute the same command. By quickly identifying large blocks of identical output, processing effort can then be concentrated on identifying the character differences in the remaining lines of text.

For lines in the response file identified as different from the corresponding line in the reference file, a string matching algorithm can be applied to identify which characters differ between the two lines. According to some embodiments, Ratcliff's algorithm can be used to identify the longest common subsequences in the two lines, and thereby highlight the different characters. However, for some data, Ratcliff's algorithm is found to give false matches which may lead to confusing output.

According to some embodiments a ‘smart-merge’ algorithm is used to determine which characters differ between corresponding lines of text. The smart-merge algorithm is based on Ratcliff's algorithm but has been modified to improve correspondence between matched characters and is particularly appropriate for lines of equal lengths. The different operation of the Ratcliff and smart-merge algorithms is highlighted in the example shown in FIG. 5.

In the example shown in FIG. 5, two time values are presented in the response and reference files. The Ratcliff algorithm operates to recursively identify the longest common substring, and in so doing identifies that the “:53” minutes of one value corresponds to the “:53” seconds of the other. While matching fewer characters, Smart-Merge identifies the alignment of the colons and thereby provides more operator friendly output.

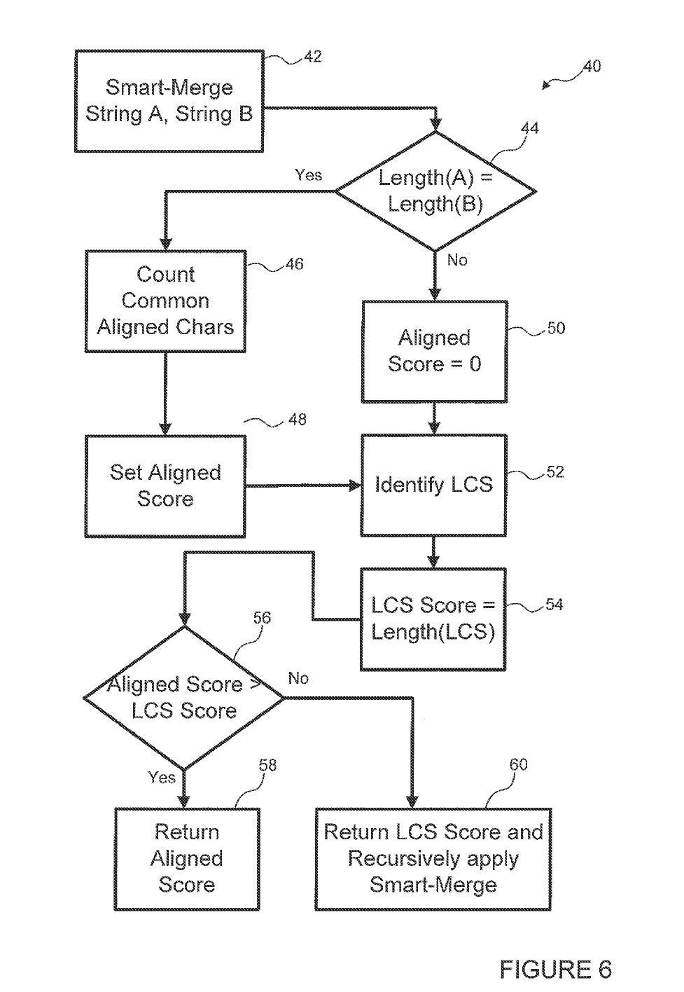

FIG. 6 illustrates the Smart-Merge algorithm 40 according to some embodiments of the invention. The Smart-Merge algorithm is called with an input of two strings of characters at step 42, string A and string B from the response and reference files respectively. These strings are compared to determine a similarity between the strings and to identify common characters. According to the method illustrated in FIG. 4 the length of string A is compared to the length of string B at step 44, to determine if the two strings have the same length. If the two strings do have the same length, the number of common aligned characters is determined at step 46, that is each character in string A is compared to the character at the same position in string B and the number of characters found to be identical is counted to provide an aligned score for the two strings at step 48.

However, if the length of the two strings is not equal, the aligned score is set to zero in step 50.

The two strings, A and B, are also compared at step 52 to identify the longest common substring (LCS) of string A and string B, and the number of characters in the longest common substring is provided as a LCS score for the two strings at step 54.

In step 56 of the method of FIG. 6 the aligned score is compared against the LCS score to determine which score has the greatest value. If the aligned score is greater than the LCS score, then the aligned score is returned by the Smart-Merge algorithm at step 58 as the calculated similarity score, or Smart-Merge score, for the two strings. However, if the LCS score is greater than the aligned score, the Smart-Merge algorithm is then recursively called in step 60 on any remaining unmatched portions of the strings to the left and to the right of the longest matched substring. In this case, the returned Smart-Merge score equals:

smart_merge(string A,string B)=L+smart_merge(Left_of(A),Left_of(B))+smart_merge(Right_of(A),Right_of(B))

where L equals the length of the longest common substring between string A and string B, and Left_of( ) is the substring at the left of the longest common substring, and Right_of( ) is the substring to the right of the longest common substring.

Thus, if it is determined that the strings A and B are not of the same length, no aligned score is calculated, and the LCS score is used for that iteration of the Smart-Merge algorithm. The Smart-Merge algorithm is then run again on any remaining substrings to the right or left of the longest common substring which may then comprise strings of equal length.

The method of FIG. 6 provides a way of determining a similarity, and of matching characters, between two text strings that automatically adapts to identifying good aligned correlation between the strings when present, and reverts to Ratcliff's algorithm to recursively find the longest common substrings when operating on unequal length strings or strings with little or no aligned correlation.

The above described two stage process for identifying differences between the response file and the reference file provides good performance by allowing rapid identification of large amounts of identical text, and then performing more processor intensive string comparisons on lines of text identified as different. Furthermore, the method may be particularly applicable to multi-core, or multi-processor systems in allowing the comparison of any response file with the reference file to be performed as an independent thread of execution.

According to some embodiments of the invention, the method is adapted to use Levenshtein's distance to reduce the processing requirements of applying Ratcliff's algorithm to the text data. According to these embodiments, for a pair of strings being compared a matrix can be generated defining the number of operations (operations being defined as one of substitutions, deletions, or insertions of a single character) required to transform one string into the other. Having generated this matrix, the longest common substring can easily be identified. The calculated matrix can also be used for subsequent iterations of the method, reducing the number of times the characters of the two strings are read from memory.

While traditionally used to determine a ‘distance’ between two strings of characters, Levenshtein's algorithm can be applied to the line checksums as described above, in order to quickly identify common blocks of lines present in the reference and response files.

Some commands when executed on nodes 6 may not always respond with lines in the same order, for example due to race conditions relating to execution of the command. In such cases, the order to the lines in the response may not be predictable, leading to the order to lines in some response files being ‘shuffled’ with respect to the reference file. Applying the method of FIG. 3 to such shuffled response files may lead to blocks of text not being identified as identical due to the lines appearing in the wrong order in the response file.

According to some embodiments of the invention, a re-ordering algorithm is applied to reorder lines in the response file based upon similarity with lines in the reference response. The re-ordering improves the correspondence between lines in the re-ordered response file and the reference response file.

The re-ordering algorithm operates on each line in the reference response in turn, identifying the line with the greatest similarity in the response file that has not already been identified. The identified line is then moved to a position in the response file corresponding to the position of the line being compared in the reference file, moving all other lines in the response file down one step if necessary. A similarity threshold is applied such that if a line has no corresponding line with a sufficiently high similarity score, no line from the response file is assigned and the algorithm continues with the next line of the reference file.

According to some embodiments of the re-ordering algorithm, a re-ordering window is implemented limiting the search for corresponding lines to within a certain window in the response file. For example, a number of lines N can be specified such that only the following N lines are searched for corresponding lines. For lines out of order due to race conditions, it is expected that such lines will only be moved by a small number of positions, therefore implementing a window may significantly reduce the processing time required to match lines for re-ordering while still ensuring the correct line is matched.

A number of different string comparison techniques can be used to determine a similarity score for pairs of lines to be used in accordance with embodiments of the invention to determine when lines of the response file should be re-ordered, for example Ratcliff's algorithm (as discussed above), Soundex, Hamming distance, and Levenshtein's comparison.

The re-ordered response file can then be input into the method of FIG. 3 to identify identical blocks of text, along with one or more different lines of text.

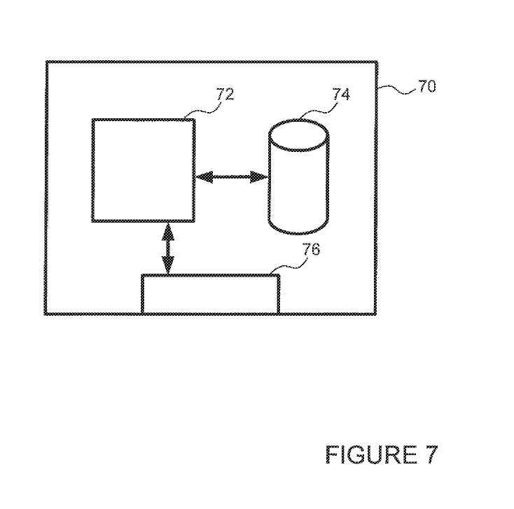

FIG. 7 illustrates a computing node 70 suitable for implementing some embodiments of the invention. For example, the illustrated node 70 may be operable as the administration terminal 2, the management node 4, or as a node 6. The computing node 70 comprises a processor 72, coupled to a memory 74 operable to store program instructions executable by the processor 72 to perform one or more steps of at least one of the methods illustrated in FIG. 2, 3 or 6. The computing node further comprises a network interface 76 coupled to the processor, and operable to allow the computing node to communicate with other entities over a network.

According to some embodiments of the invention, different populations of differences in the response files may be identified, with each population corresponding to a particular variant found in the response files received from the nodes 6. Identified populations can then be highlighted when the output is displayed. Portions of response files that are always different may also be noted (for example IP or MAC addresses).

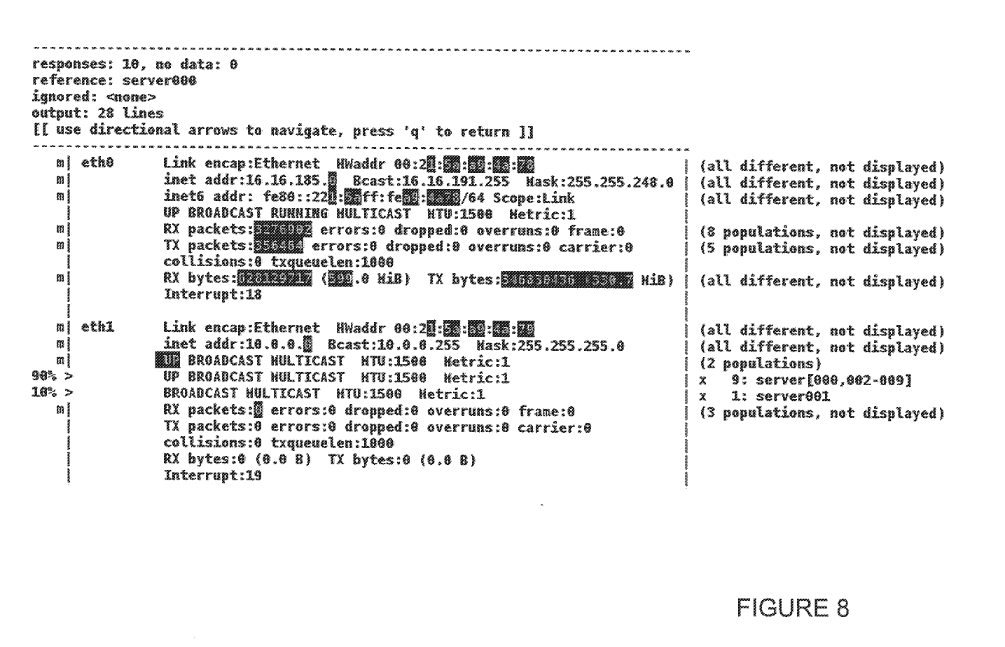

Having identified the differences between response files and a selected reference file, embodiments of the invention may then generate a user friendly, and tunable, output. The output may be formatted with statistics, showing context data or showing only the difference data. According to some embodiments, the reference file is displayed with annotations, and with colored highlighting of the reference file text. The resulting output can then be pushed to a pager tool for immediate display to an operator, or saved in a file for later study. An example output is shown in FIG. 8.

FIG. 8 illustrates the merged output displayed when the ifconfig command is executed on ten hosts, and the output is processed according to embodiments of the invention. Thus, in the reference file is displayed with the determined differences between responses highlighted. In particular, it will be noted that in each response the MAC addresses and IP addresses are different, as would be expected, but do not result in each response being duplicated in the output.

While embodiments of the invention have been described in the context of outputs from computing nodes in a high performance computing cluster, it will be recognized that the invention is not limited to that specific application, and that embodiments of the invention may be applicable to any scenario in which a number of text files need to be compared.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of identifying a block of text data common with reference text data, the method comprising:
for each line of text in the text data, calculating a checksum value associated with that line of text; and
recursively identifying the longest common block of lines of text between the text data and the reference text data based on the calculated checksum values.

2. The method of claim 1, further comprising calculating a checksum value for each line in the reference text data.

3. The method of claim 1, wherein recursively identifying the longest common block of lines of text further comprises applying Ratcliff's pattern matching algorithm to the calculated checksum values.

4. The method of claim 1, further comprising re-ordering the lines of text of the text data to reduce differences between the text data and the reference text data.

5. A method of identifying a portion of text data common with reference text data, the method comprising:
obtaining the text data and the reference text data, the text data and the reference text data comprising a number of lines of text;
identifying one or more lines of text of the text data that are common to the lines of text of the reference text data; and
for one or more further lines of text of the text data that are not common to the lines of text of the reference text data, comparing the line of text of the text data with a corresponding line of text of the reference data to identify one or more common characters of the line of text.

6. The method of claim 5, wherein identifying one or more lines of text of the text data that are common to the lines of text of the reference text data further comprises:
for each line of text in the text data, calculating a checksum value associated with that line of text; and
recursively identifying the longest common block of lines of text between the text data and the reference text data based on the calculated checksum values.

7. The method of claim 5 further comprising the step of re-ordering the lines of text of the text data to correspond to the line of text of the reference text data.

8. The method of claim 5, further comprising determining that any characters not identified as common characters differ between the text data and the reference text data.

9. The method of claim 5, further comprising obtaining a plurality of text data and wherein said identifying and comparing are performed for each of the plurality of text data.

10. The method of claim 9, further comprising:
determining that any characters not identified as common characters differ between the text data and the reference text data; and
identifying populations of differences between the plurality of text data and the reference text data.

11. A method of calculating a similarity score between two text strings, the method comprising:
determining a number of common aligned characters in the two strings; and
identifying a longest common substring between the two strings;
wherein if the determined number of common aligned characters is greater than a length of the longest common substring, returning the determined number of common aligned characters as the similarity score.

12. The method of claim 11, wherein, if the length of the longest common substring is greater than the number of common aligned characters, returning the length of the longest common substring as the similarity score.

13. The method of claim 12, further comprising, if the length of the longest common substring is greater than the number of common aligned characters, recursively performing the method on remaining portions of the two text strings not including the longest common substring; and
adding the returned similarity scores for the remaining portions of the two text strings to the length of the longest common substring to calculate the similarity score for the two strings.

14. The method of claim 13, wherein identifying the longest common substring between the two strings further comprises applying Ratcliff's pattern matching algorithm to the two strings.
